(19) United States
(12) Patent Application Publication
(10) Pub. No.: US 2011/0128919 A1
(43) Pub. Date: Jun. 2, 2011

(54) DEVICE AND METHOD FOR SELECTING TRANSCEIVER IN MOBILE COMMUNICATION SYSTEM

(75) Inventors: Soeng-Hun KIM, Suwon-si (KR); Joon-Young CHO, Suwon-si (KR); Kyeong-In JEONG, Hwaseong-si (KR)

(73) Assignee: SAMSUNG ELECTRONICS CO. LTD., Suwon-si (KR)

(21) Appl. No.: 12/627,543

(22) Filed: Nov. 30, 2009

(51) Int. Cl. H04L 12/50; H04W 40/00

(52) U.S. Cl. 370/329; 370/360

(57) ABSTRACT

A device and method for selecting one of a plurality of transceivers in a mobile terminal are provided. The method includes receiving information about the plurality of transceivers, receiving information about at least one transceiver being used, and transmitting a transceiver switching message. By selectively choosing the transceivers in the mobile terminal, radio resources of a mobile communication system can be more optimally used.

### BACKGROUND OF THE INVENTION

1. Field of the Invention

The present invention relates to mobile communication technology. More particularly, the present invention relates to a method and device for selecting one of a plurality of transceivers included in a mobile terminal of a mobile communication system.

2. Description of the Related Art

Voice communication between users of mobile communication terminals has been provided for many years by various service providers. As use of mobile communication terminals has become more widespread, users now desire advanced services such as email, Internet access, video streaming, real time gaming, and the like. One technology that is under development to provide such advanced services is the 3^{rd} Generation Partnership Project (3GPP) Long Term Evolution (LTE) system. A goal of the LTE system is to provide advanced services with a download speed of 100 Mbps.

Unlike a voice service, when a data service is provided, the amount of resources allocated to a mobile terminal is determined according to several variables, for example the amount of data to be transmitted and the channel states. Therefore, in radio communication systems, such as mobile communication systems, a scheduler allocates transmission resources by considering the amount of resources to be transmitted, the channel states, the amount of data, and the like. This situation is similarly applied to the LTE system wherein the scheduler, located at a base station (i.e., evolved Node B (eNB)), manages radio transmission resources.

In recent years, the LTE communication system has been further developed to achieve even higher transmission rates by incorporating a variety of technologies. That is, an LTE-Advanced (LTE-A) communication system has been developed by combining the LTE communication system with a variety of technologies. One such technology is carrier aggregation.

Unlike a data transmission/reception method where a mobile terminal transmits/receives data using only one forward carrier or one reverse carrier, carrier aggregation refers to a data transmission/reception method where the mobile terminal transmits/receives data using a plurality of forward carriers or a plurality of reverse carriers. In order to aggregate carriers, the mobile terminal includes a plurality of transceivers. If the mobile terminal includes a plurality of transceivers that support frequency bands of carriers to be aggregated, it is important to select the optimal transceiver with respect to the plurality of transceivers. This is because the potential maximum transmission rate depends on the selected transceiver. Accordingly, there is a need for a device and method for selecting a transceiver for use in a mobile communication terminal.

### SUMMARY OF THE INVENTION

An aspect of the present invention is to address at least the above-mentioned problems and/or disadvantages and to provide at least the advantages described below. Accordingly, an aspect of the present invention is to provide a device and method for optimally selecting transceivers included in user equipment in a mobile communication system.

In accordance with an aspect of the present invention, a method for selecting, by a network entity, a transceiver of a mobile terminal including a plurality of transceivers is provided. The method includes receiving information about the plurality of transceivers, receiving information about at least one transceiver being used, and transmitting a transceiver switching message.

In accordance with another aspect of the present invention, a method for determining, by a mobile terminal including a plurality of transceivers, a transceiver for use by the mobile terminal is provided. The method includes transmitting information about the plurality of transceivers, transmitting information about at least one transceiver being used, and receiving a transceiver switching message.

In accordance with still another aspect of the present invention, a method for determining, by a mobile terminal including a plurality of transceivers, a transceiver for use by the mobile terminal, is provided. The method includes receiving spectrum information including bandwidth by frequency information, respectively mapping preferable transceivers to frequency bands included in the spectrum information, and switching from a first transceiver to a second transceiver based on the received spectrum information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a configuration of a mobile communication system;

FIG. 2 is a view illustrating protocol layers of the mobile communication system according to an exemplary embodiment of the present invention;

FIG. 3 is a view describing carrier aggregation in a mobile communication system;

FIG. 4 is a view illustrating a system supporting a variety of frequency bands and User Equipment (UE) including a plurality of transceivers, according to an exemplary embodiment of the present invention;

FIG. 5 is a flowchart describing a signaling operation according to an exemplary embodiment of the present invention;

FIG. 6 is a flowchart describing a method of reporting the capability of a transceiver, according to an exemplary embodiment of the present invention;

FIG. 7 is a flowchart describing a method of reporting transceivers that are currently being used, according to an exemplary embodiment of the present invention;

FIG. 8 is a flowchart describing a method of receiving a transceiver switching command, according to an exemplary embodiment of the present invention;

FIG. 9 is a flowchart describing a method of receiving a carrier aggregation message, according to an exemplary embodiment of the present invention;

FIG. 10 is a flowchart describing a method of determining which transceiver will be mapped to a carrier that will be aggregated, according to an exemplary embodiment of the present invention;

FIG. 11 is a flowchart describing a signaling operation according to an exemplary embodiment of the present invention;

FIG. 12 is a flowchart describing operations of a UE according to an exemplary embodiment of the present invention;

FIG. 13 is a flowchart describing operations of a UE according to an exemplary embodiment of the present invention; and

FIG. 14 is a view illustrating an exemplary configuration of a UE according to an embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In the following exemplary embodiments of the present invention, an apparatus and method for determining a transceiver in a mobile terminal including a plurality of transceivers are provided. The following description is made using terms that are specific to the Long Term Evolution (LTE) and LTE-Advanced (LTE-A) systems. However, this is merely for the sake of convenience and is not to be considered a limitation in application of the invention to other systems. For example, while terms such as evolved Node B (eNB), Mobility Management Entity (MME), Serving GateWay (SGW), and User Equipment (UE) are used in the following description, the terms are considered merely examples of application of the invention to a specific type of base station, network, server, and mobile terminal.

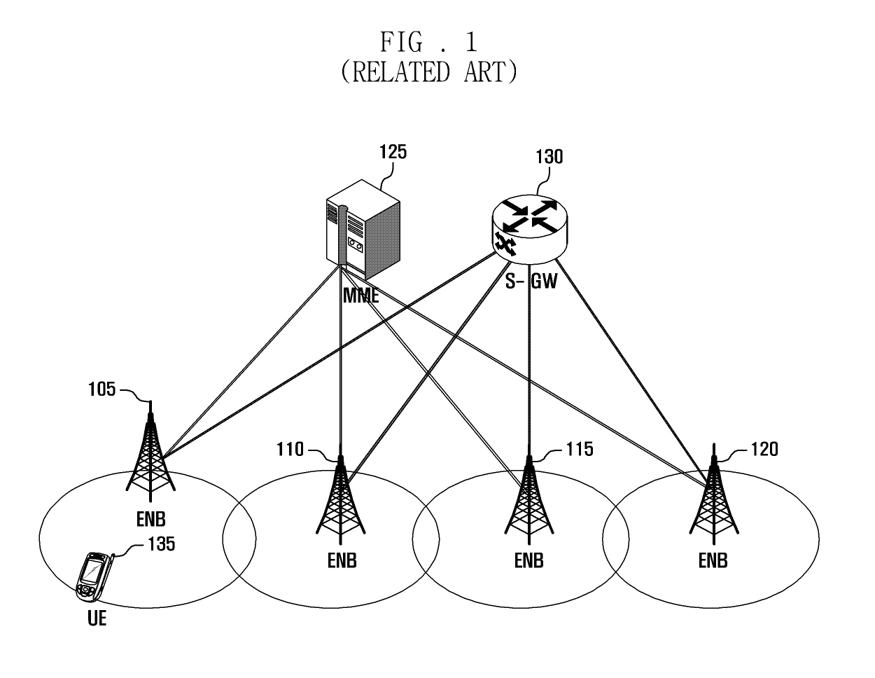

To assist in an understanding of the invention, an LTE mobile communication system is first explained with reference to FIGS. 1 to 3.

FIG. 1 is a view illustrating a configuration of an LTE mobile communication system according to an exemplary embodiment of the present invention.

Referring to FIG. 1, an LTE system includes eNBs 105, 110, 115, and 120, an MME 125, and an SGW 130. A UE 135 is connected to an external network (not shown) via the eNB 105 and SGW 130. The eNBs 105 to 120 correspond to conventional eNBs in a Universal Mobile Telecommunication System (UMTS) but perform a more complicated function than the conventional node Bs.

The eNB 105 is connected to the UE 135 via a radio channel. In the LTE system, a real-time service, such as a Voice over Internet Protocol (VoIP), and all user traffic are serviced via a shared channel. The eNBs 105 to 120 collect state information regarding UEs and perform scheduling based on the collected state information. In general, one eNB controls a plurality of UEs. The LTE system employs a radio access technology, such as an Orthogonal Frequency Division Multiplexing (OFDM) scheme, having a maximum bandwidth of about 20 MHz. The LTE system also uses an Adaptive Modulation and Coding (AMC) scheme that determines a modulation scheme and a channel coding rate to adapt to a channel state of the UE being served.

The MME 125 refers to a device that performs a variety of control functions such as authentication, authorization, security negotiations, and the like. The MME 125 is connected to a plurality of eNBs using an S1 connection.

The SGW 130 refers to a device that provides a data bearer for forwarding and receiving packets to and from an eNB serving a UE. The SGW 130 generates or removes a data bearer according to the control of the MME 125.

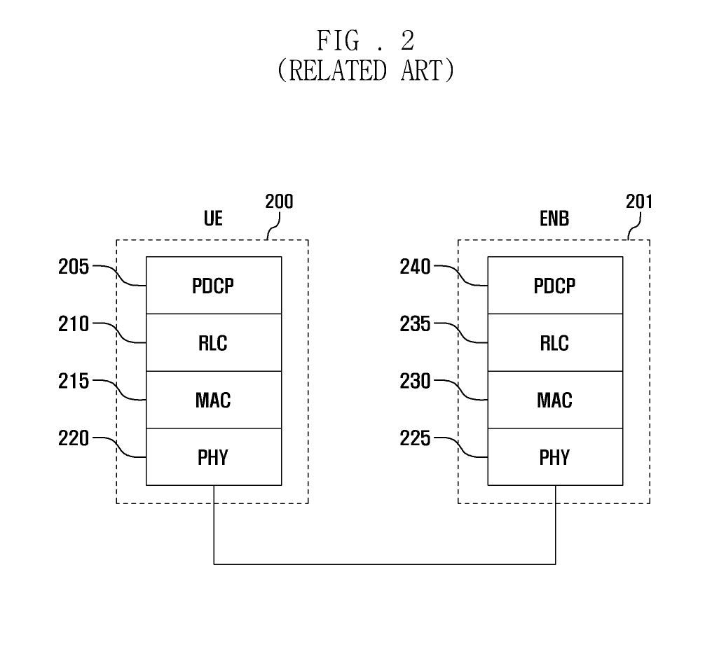

FIG. 2 is a view illustrating protocol layers of an LTE mobile communication system according to an exemplary embodiment of the present invention.

Referring to FIG. 2, the radio protocol layers of both a UE 200 and an eNB 201 of the LTE system include a Packet Data Convergence Protocol (PDCP) layer 205 and 240, a Radio Link Control (RLC) layer 210 and 235, and a Medium Access Control (MAC) layer 215 and 230. The PDCP layers 205 and 240 serve to compress/de-compress IP headers. The RLC layers 210 and 235 each reconfigure a PDCP Packet Data Unit (PDU) to a proper size, and perform an Automatic Repeat reQuest (ARQ) process. The MAC layers 215 and 230 are linked to a plurality of RLC layer devices included in a UE. The MAC layers 215 and 230 multiplex RLC PDUs to the MAC PDUs and de-multiplex RLC PDUs from the MAC PDUs.

PHYsical layers (PHYs) 220 and 225 channel-encode and modulate upper layer data, generate OFDM symbols from the modulated data, and transmit the generated symbols via a radio channel. The PHY layers 220 and 225 also receive the OFDM symbols via a radio channel, demodulate and channel-decode the received OFDM symbols, and transfer the decoded and demodulated symbols to the upper layer.

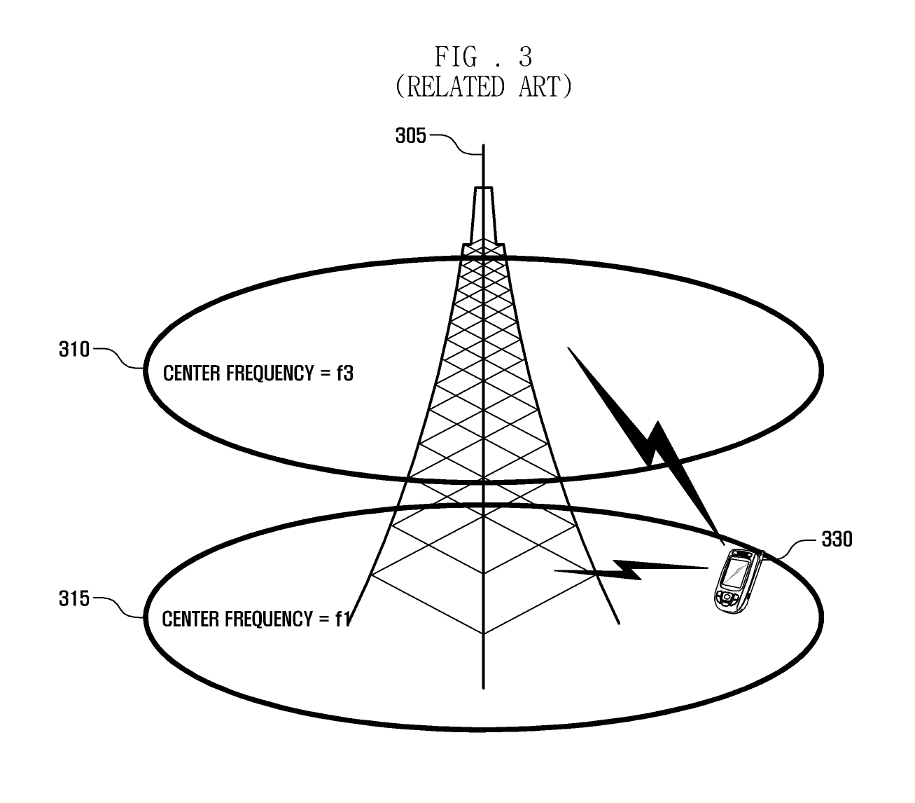

FIG. 3 is a view describing carrier aggregation in an LTE mobile communication system according to an exemplary embodiment of the present invention.

Referring to FIG. 3, in the LTE system, eNB 305 is providing service to UE 330. Generally in an LTE system, an eNB transmits and receives signals to the UEs it serves using a plurality of carriers located in different frequency bands. For example, the eNB 305 may transmit a first carrier 315 having a center frequency f1 and a second carrier 310 having a center frequency of f3. Typically a UE transmits and receives data to and from the eNB using only one of the two carriers. On the contrary, the UE 330, according to an exemplary embodiment of the present invention, may simultaneously transmit and receive signals using both the first carrier 315 and the second carrier 310 to and from the eNB 305. That is, the UE 330 is capable of aggregating carriers and thus can simultaneously transmit and receive a plurality of carriers to and from the eNB 305. As the eNB 305 allocates more carriers to the UE 330 that is capable of aggregating carriers, the transmission rate of the UE 330 is increased.

As the mobile communication system expands, the number of frequency bands that may be allocated to a mobile terminal is increased. Accordingly, the number of frequency bands that a mobile terminal must support correspondingly increases. For example, in the conventional 3^{rd} Generation (3G) mobile communication system, a mobile terminal may support several frequency bands, such as 900 MHz, 1.8 GHz, 2.1 GHz, etc., so as to provide service in a home country and to support a roaming service. However, in the LTE-A system, where frequency bands are newly allocated and carriers of a plurality of frequency bands may be aggregated, a plurality of frequency bands must be capable of being used in a wide frequency range, for example, from about 450 MHz to about 3.5 GHz.

One transceiver provided with a UE can support a plurality of frequency bands. However, a transceiver cannot transmit or receive data via more than one frequency band at the same time. Therefore, in order to aggregate carriers via a plurality of frequency bands, the UE includes a plurality of transceivers. Since covering all frequency bands by the plurality of transceivers causes the price of the UE to increase, it is preferable to properly set frequency bands supported by transceivers included in the UE in such a way that the frequency bands are properly superposed and the frequency bands are not exceedingly crowded in any one of the transceivers. Furthermore, it is desirable that the maximum bandwidth that can be processed by the UE is divided by the number of transceivers, so that a variety of frequency bands can be combined and thus the optimum carrier aggregation can be acquired. When communication is attempted via a particular frequency band that is supported by a plurality of transceivers whose maximum bandwidths differ from each other, the carrier aggregation effect can differ depending on which transceiver is used.

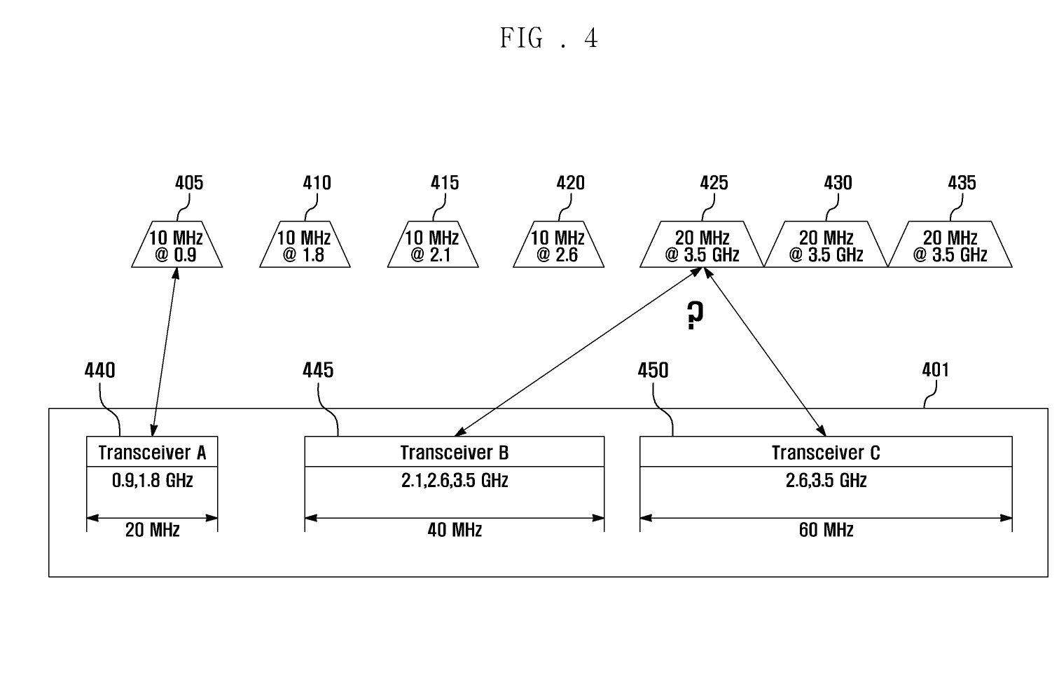

FIG. 4 is a view illustrating a system supporting a variety of frequency bands and a user equipment including a plurality of transceivers, according to an exemplary embodiment of the present invention.

Referring to FIG. 4, a UE 401, including a transceiver A 440, a transceiver B 445, and a transceiver C 450, is performing communication in a system having a carrier 405 of 10 MHz at 900 MHz frequency band, a carrier 410 of 10 MHz at 1.8 GHz frequency band, a carrier 415 of 10 MHz at 2.1 GHz frequency band, a carrier 420 of 10 MHz at 2.6 GHz frequency band, and three carriers 425, 430 and 435 each of 20 MHz at 3.5 GHz frequency band. The frequency bands and the maximum bandwidth of the transceivers 440, 445, and 450 of UE 401 are allocated as described in Table 1.

TABLE 1

| | Frequency bands | Max. bandwidth |
|---|---|---|
| Transceiver A | 900 MHz, 1.8 GHz | 20 MHz |
| Transceiver B | 2.1 GHz, 2.6 GHz, 3.5 GHz | 40 MHz |
| Transceiver C | 2.6 GHz, 3.5 GHz | 60 MHz |

As illustrated in FIG. 4, if the UE is linked to the carrier 405 of 900 MHz via transceiver A 440 and aggregates another carrier 425 at a frequency band of 3.5 GHz, it can use either of transceiver B 445 or transceiver C 450 that supports a frequency band of 3.5 GHz. However, if the UE uses transceiver B, it cannot use all of the remaining carriers 430 and 435 having a frequency band of 3.5 GHz since the combined carrier bandwidth is 60 MHz while the transceiver B has a maximum bandwidth of 40 MHz. Moreover, if the UE is switched from transceiver B to transceiver C to aggregate all three carriers 425, 430 and 435, the switching from the transceiver B to the transceiver C causes a delay.

In order to address the above mentioned problems, exemplary embodiments of the present invention are implemented in such a way that a UE reports frequency bands and maximum bandwidths of the transceivers included therein and information regarding the currently used transceiver to an eNB. Using the received information, the eNB instructs the UE as to which transceivers the UE may use when the UE aggregates carriers.

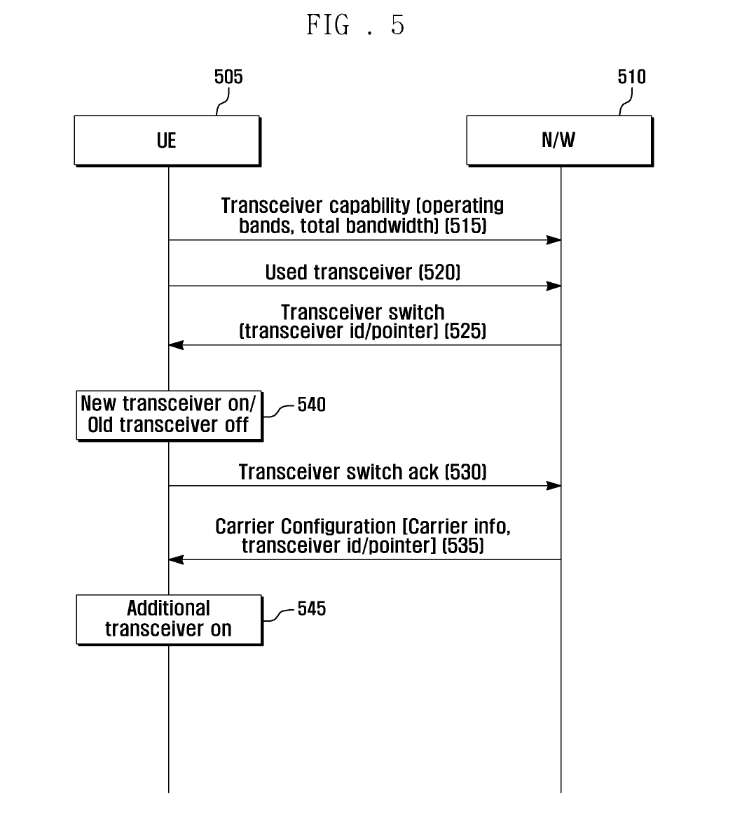

FIG. 5 is a flowchart describing a signaling operation according to an exemplary embodiment of the present invention.

Referring to FIG. 5, in step 515 a UE 505 reports the capability of transceivers installed therein to a network (N/W) 510. The N/W 510 may comprise an eNB serving the UE 505 or an upstream component such as an MME or SGW serving the eNB. In an exemplary implementation, the UE 505 reports its transceiver capability at a time point before communication is performed with the N/W 510 or during an initial registration process, such as when the UE 505 is powered on. Since the capability of the transceivers is not actively changed, it may be designed such that the reporting of the capability of the transceivers is performed only at the request of the N/W 510. In an exemplary embodiment, the capability of the transceivers may include the information described above in Table 1. Moreover, in an exemplary implementation, the frequency bands listed in Table 1 may be expressed as an integer serial number. That is, the frequency bands may be respectively mapped to an integer serial number. For example, a frequency band of 2.1 GHz may be mapped as frequency band 1, a frequency band of 1.8 GHz may be mapped as frequency band 4, etc. In that case, the UE 505 can report a frequency band serial number to the N/W 510 where the frequency band serial number is mapped with a frequency band in the list, and is supported by a corresponding transceiver of the UE 505.

An example of a control message for reporting the capability of transceivers is described with reference to Table 2. In Table 2, the greater-than symbol (>) refers to a level of corresponding information. Each additional greater-than symbol used to indicate a level of information corresponds to a lower level of information. For example, the information associated with two greater-than symbols (>>) is sub-information of the information associated with one greater-than symbol (>).

TABLE 2

| Name of Information | | |
|---|---|---|
| Element | Singular/Plural | Contents |
| > Information | Plural (the number of | |
| regarding transceiver | transceivers) | |
| capability | | |
| >> Transceiver | Singular | 0 ≦ integer ≦ (n − 1), where n is |
| identifier | | the max. number of transceivers |
| | | included in one UE |
| >> List of frequency | Singular | |
| bands | | |
| >>> Serial numbers | Plural (the number of frequency | 1 ≦ integer ≦ m, where m is the |
| corresponding to | bands supported by the | max. number of frequency |
| frequency bands | transceiver) | bands defined for an LTE-A |
| | | system |
| >>> Max. bandwidth | Singular | Max. bandwidth that can be |
| | | processed by transceiver |

As described above, the N/W 510 is made aware of transceivers contained in the UE 505 by the control message configured as in Table 2. The N/W 510 should also be made aware of a transceiver that the UE 505 is currently using so as to determine a transceiver to which a carrier will be mapped. Using this process, the UE can obtain an improved capability. To this end, the UE reports information regarding the currently used transceiver to the network in step 520. The information may contain the identifier of the currently used transceiver or other information that can identify transceivers. An example of other information includes information that indicates the order (or position) in which the transceivers are reported in a transceiver capability report message. An example of a control message for reporting a currently used transceiver is described with reference to Table 3.

TABLE 3

| Name of | | |
|---|---|---|
| Information | | |
| Element | Singular/Plural | Contents |
| > List of transceivers | Plural (the number | |
| that are currently | of transceivers that | |
| being used | are currently being used) | |
| >> Transceiver | Singular | 0 ≦ integer ≦ (n − 1) |
| Identifier | | |
| >> Serial number of | Singular | 1 ≦ integer ≦ m |
| frequency band | | |

When the N/W 510 receives the control message described in Table 3, it detects a transceiver and a frequency band, which are currently used by the UE 505.

The N/W 510 considers information regarding the capability of transceivers located at the UE 505, information regarding the currently used transceiver, and a frequency band situation of a cell where the UE 505 is located. If necessary, the N/W 510 may command the UE 505 to switch the currently used transceiver to another transceiver. For example, if the UE 505 is using a first transceiver having a maximum bandwidth of 20 MHz at a frequency band, and the UE 505 can aggregate carriers of up to 40 MHz at the frequency band, the N/W 510 commands the UE 505 to use a second transceiver that can support the frequency band that has a wider bandwidth than that of the first transceiver. Accordingly, the N/W 510 transmits a transceiver switch command to the UE 505 in step 525. Upon receipt of the transceiver switch command message, the UE 505 switches on a new transceiver according to the command in the received transceiver switch command message and switches off the old transceiver that it is currently using in step 540. After that, the UE 505 transmits a transceiver switch acknowledgement message to the network in step 530. An example of a control message for a transceiver switching operation is described with reference to Table 4.

TABLE 4

| Name of | | |
|---|---|---|
| Information | | |
| Element | Singular/Plural | Contents |
| > List of transceiver | plural (the number | |
| to be switched | of transceivers | |
| | to be switched) | |
| >> Serial number of | Singular | Frequency band to which |
| frequency band | | transceiver is switched |
| >> Transceiver | Singular | Transceiver Identifier used in |
| Identifier | | the frequency band described |
| | | above |

Again, when the UE 505 receives the control message transmitted by the N/W 510 in step 525, it switches on a transceiver corresponding to the transceiver identifier contained in the message, maps the transceiver to a carrier of the frequency band indicated by the frequency band number, and switches off the previously used transceiver to which the carrier was mapped. After that, the UE 505 transmits a transceiver switch acknowledgement message to the N/W 510 in step 530.

The N/W 510 may transmit a control message to the UE 505 directing the UE 505 to aggregate a particular carrier at a particular frequency band in step 535. In an exemplary implementation, the control message contains a frequency band of a carrier to be aggregated, center frequency information, and bandwidth information. The control message also contains an identifier regarding a transceiver to be mapped to a carrier to be newly aggregated or information distinguishing transceivers. The UE 505 switches on a transceiver indicated in the message and then aggregates carriers by the newly added transceiver in step 545. An example of a control message for commanding carrier aggregation is described with reference to Table 5. In an alternative exemplary embodiment, the N/W 510 may direct the UE 505 to aggregate a plurality of carriers having different frequency bands. In that case, the control message would contain information regarding the frequency bands of the different carriers to be aggregated, center frequency information and bandwidth information as well as identifiers regarding transceivers to be mapped to the different carriers. In table 5, the transceiver identifier may either be an explicit identifier or an implicit identifier. For example, an implicit identifier may be a pointer that indicates the position of the selected transceiver in the order of the transceivers included in the transceiver capability message sent most recently. For example, the implicit identifier of 0 indicates that the transceiver which appears first in the transceiver capability message is to be used.

TABLE 5

| Name of | | |
|---|---|---|
| Information | | |
| Element | Singular/Plural | Contents |
| > Carrier | Plural (the | |
| information | number of | |
| | carriers to | |
| | be aggregated) | |
| >> Center frequency | Singular | Center frequency of aggregated |
| | | carrier |
| >> Bandwidth | Singular | Bandwidth of aggregated carrier |
| >> Transceiver | Singular | Aggregated carrier and transceiver |
| identifier | | identifier to be mapped |

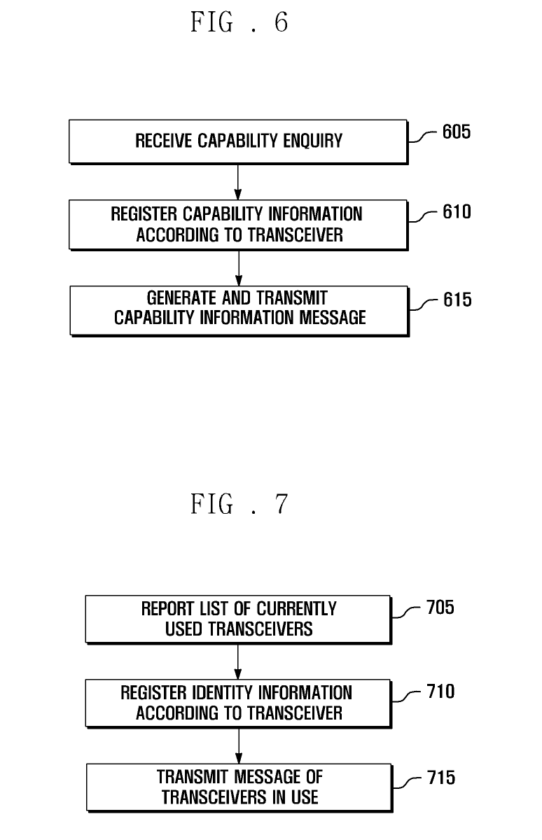

FIG. 6 is a flowchart describing a method of reporting the capability of a transceiver, according to an exemplary embodiment of the present invention.

Referring to FIG. 6, the UE receives a UE capability enquiry message transmitted from a N/W entity in step 605. The N/W entity may transmit the message to the UE to command the UE to report the capability thereto. In an exemplary implementation, this enquiry may be performed when UE, whose capability is not known by the network, is newly registered with the network.

The UE configures capability information regarding its transceivers in step 610. That is, the UE registers identifiers, a list of supported frequency bands, and the maximum bandwidths, according to transceiver in the capability information. After that, the UE generates a UE capability report message including the capability information regarding the transceivers of the UE, and transmits it to the N/W in step 615.

FIG. 7 is a flowchart describing a method of reporting transceivers that are currently being used, according to an exemplary embodiment of the present invention.

In step 705, the UE reports the currently used transceiver to the N/W if the following situations occur:
a. When the UE changes from an idle state to a connected state within a certain cell, a plurality of transceivers included in the UE support a frequency band of the cell and at least two or more of the transceivers have different maximum bandwidths.
b. When the user performs a handover from a heterogeneous network, such as a Global System for Mobile communications (GSM) or Universal Mobile Telecommunication System (UMTS), to an LTE network, a plurality of transceivers included in the UE support a frequency band of the cell to which a handover is performed and at least two or more of the transceivers have different maximum bandwidths.

In step 710, the UE registers an identifier of a transceiver that is currently operated and a serial number of a frequency band that the transceiver is currently using and thus configures information regarding the transceiver that is currently being operated. Of course, the UE may be operating more than one transceiver. In that case, the UE registers information in step 710 of all transceivers being used. In step 715, the UE transmits a message containing the list of currently operated transceivers to the N/W.

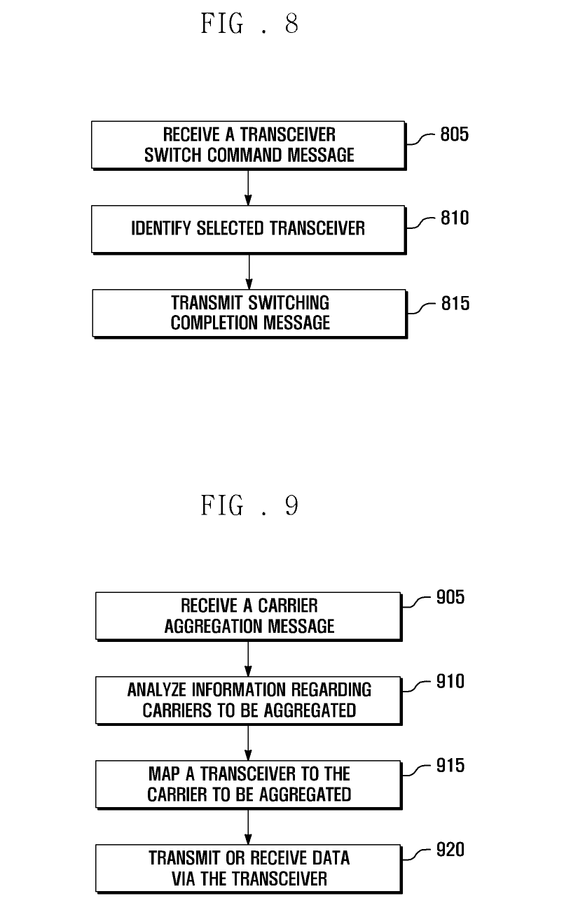

FIG. 8 is a flowchart describing a method of receiving a transceiver switching command, according to an exemplary embodiment of the present invention.

Referring to FIG. 8, the UE receives a transceiver switch command message from the N/W in step 805. More particularly, if, at the UE, there is a transceiver whose maximum bandwidth is closer to a supported bandwidth at a corresponding frequency band than that of a transceiver that is currently being used, the N/W transmits a transceiver switch command message to the UE. For example, if the UE, which can aggregate carriers up to 40 MHz at a frequency band, is using a first transceiver having a maximum bandwidth of 20 MHz at the frequency band, the N/W may command the UE to use a second transceiver that can support the frequency band and whose maximum bandwidth is wider than that of the first transceiver. In an exemplary implementation, the transceiver switch command may be contained in another control message and then transmitted to the UE.

When the UE receives the transceiver switch command message at step 805, it identifies a transceiver and a frequency to be switched according to the information contained in the transceiver switch command message in step 810. In an exemplary embodiment, the transceiver switch command message contains an identifier of a selected transceiver and information regarding a frequency band at which the transceiver will be used. The UE replaces the currently operated transceiver with the selected transceiver at the frequency band at which the selected transceiver will be used. More particularly, if the selected transceiver is not being used, the UE switches on the selected transceiver and then replaces the currently used transceiver with the selected transceiver at a corresponding frequency band. That is, the switching of a transceiver at a certain frequency band means that a transceiver that is being used at the frequency band is stopped and a selected transceiver is operated thereat. If the selected transceiver is currently being operated at a certain frequency band, the UE may switch the currently used transceiver from the currently used frequency band to a new frequency band designated according to the command message.

When the UE has finished the switching operation at step 810, it transmits a transceiver switching completion message to the N/W in step 815.

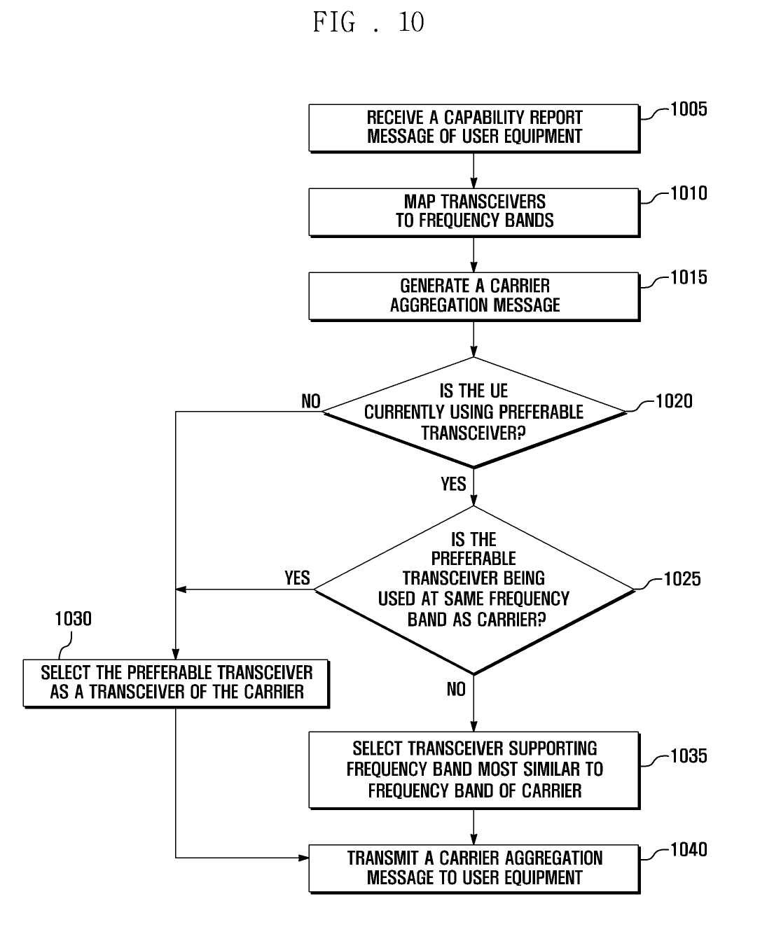

FIG. 9 is a flowchart describing a method of receiving a carrier aggregation message, according to an exemplary embodiment of the present invention.

Referring to FIG. 9, the UE receives a carrier aggregation message in step 905. In an exemplary implementation, the message contains information regarding carriers to be aggregated and information regarding transceivers to which the carriers are mapped.

The UE analyzes information regarding carriers to be aggregated in step 910. That is, the UE determines whether a carrier is aggregated and identifies the center frequencies and bandwidths of the aggregated carriers.

The UE maps the designated transceiver to the newly aggregated carrier in step 915. That is, the UE sets the transceiver designated by the carrier aggregation message to meet the center frequency and the bandwidth.

After that, the UE transmits or receives data via the transceiver in step 920.

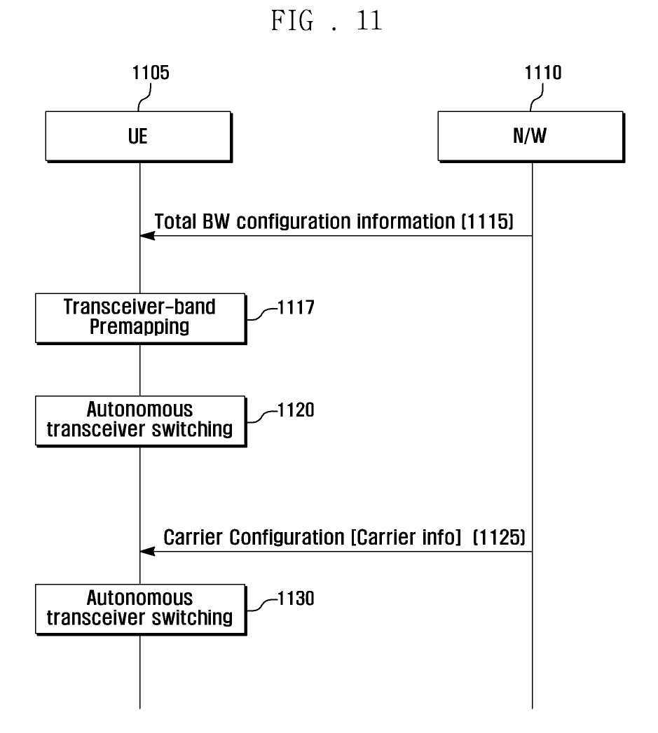

FIG. 10 is a flowchart describing a method of determining which transceiver will be mapped to a carrier that will be aggregated, according to an exemplary embodiment of the present invention.

Referring to FIG. 10, in step 1005 the N/W receives a message reporting the transceiver capability of the UE and detects the maximum bandwidths and a list of frequency bands supported by transceivers included in the UE. The N/W maps supportable frequency bands to the transceivers and thus determines preferable transceivers by frequency bands in step 1010.

In an exemplary implementation, the N/W selects the transceiver that supports the frequency band that provides the widest bandwidth. That is, of the transceivers that support a first frequency band having the widest bandwidth, the N/W selects the transceiver that provides the widest bandwidth as the preferable transceiver of the first frequency band.

Of the transceivers that support a second frequency band providing the next widest frequency bandwidth and are not selected as the preferable transceiver at the first frequency band, the N/W determines which of these transceivers supports the widest frequency bandwidth as a preferable transceiver of the second frequency band. If all transceivers supporting corresponding frequency bands have been set as preferable transceivers of other frequency bands, the N/W selects the transceiver, supporting a bandwidth that is most similar to a bandwidth provided at a corresponding frequency band, as a preferable transceiver of the frequency band. The N/W repeats these processes until the preferable transceiver is determined with respect to all frequency bands.

When the N/W decides to allow the UE to aggregate carriers, it determines in step 1015 to generate information regarding the carrier and includes it in the carrier aggregation message.

To map a carrier that will be newly aggregated to a transceiver, the N/W determines in step 1020 whether the UE is already using a preferable transceiver of a frequency band in which the carrier that will be newly aggregated is included. If the N/W determines that the UE is not using a preferable transceiver at step 1020, it selects the preferable transceiver as a transceiver of the carrier in step 1030. If the N/W determines that the UE is already using a preferable transceiver at step 1020, it determines whether the preferable transceiver is being used with respect to a frequency band that is the same as that of the carrier to be newly aggregated in step 1025.

If the N/W determines that the preferable transceiver is being used with respect to a frequency band that is the same as that of the carrier at step 1025, it proceeds to step 1030 where the preferable transceiver is selected as a transceiver of the carrier to be newly aggregated. If the N/W determines that the preferable transceiver is already being used with respect to a frequency band that differs from that of the carrier to be newly aggregated at step 1025, it selects another transceiver as a transceiver of the carrier in step 1035. Here, the selected transceiver supports a frequency band of a carrier to be newly aggregated, is not the preferable transceiver, is not yet used, but supports a bandwidth most similar to that of the frequency band of the carrier that will be newly aggregated.

The N/W transmits a control message, indicating that the UE aggregates carriers using the selected transceiver, to the UE in step 1040 after which the process according to the exemplary embodiment is ended.

In another exemplary embodiment, a method is provided in which a transceiver that the UE will use is selected according to a rule. It is important for the system to identify the distribution of bandwidths by frequency bands so that a UE having a plurality of transceivers can select a proper transceiver. When a plurality of transceivers support a frequency band, it is preferable to select a transceiver that can support a bandwidth that is closest to the bandwidth of the frequency band. That is, a transceiver must be selected with respect to a particular bandwidth so that its achievable transmission rate can be the highest in a corresponding system. To this end, the corresponding system must know how much bandwidth (e.g., MHz) the frequency bands provide. The N/W also provides a control message containing the information to UE. The control message contains frequency bands, provided by the N/W controlling a cell where the UE is located, and bandwidth information according to frequency bands. When the UE receives the information, it determines which transceiver is the most suitable according to frequency bands. After that, when a carrier of a particular frequency band is added to the communication system, the UE maps the carrier to the most suitable transceiver to the frequency band.

In the following description, an exemplary process in which the UE reports a transceiver capability to the N/W is substantially the same as previously described. Accordingly, its explanation will be omitted in the following description for the sake of convenience.

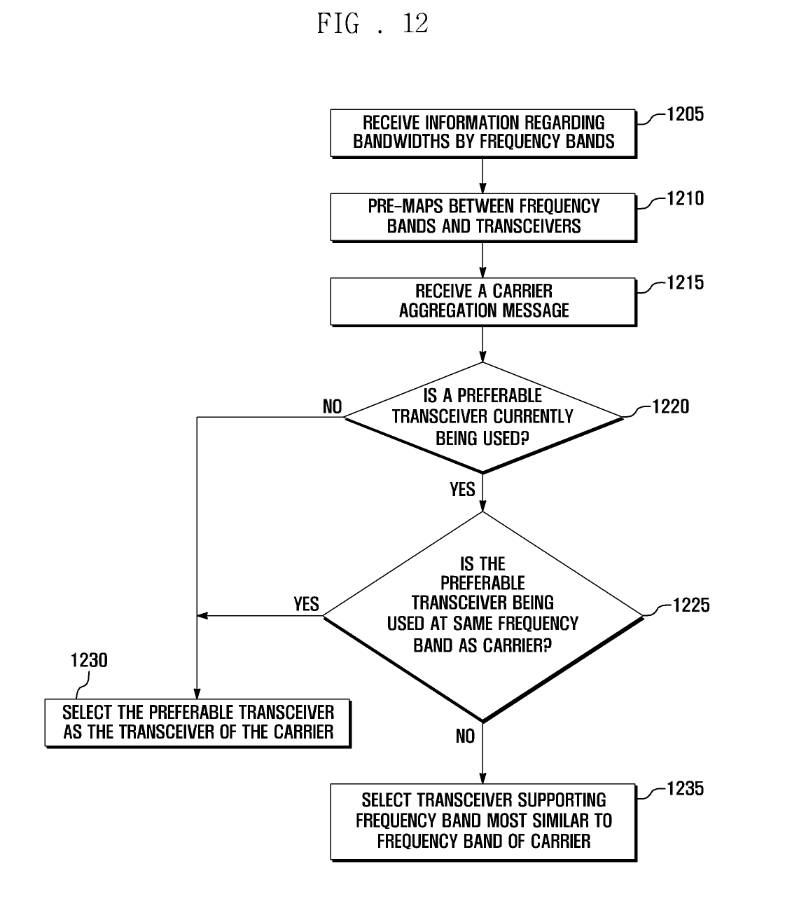

FIG. 11 is a flowchart describing a signaling operation according to an exemplary embodiment of the present invention.

Referring to FIG. 11, in step 1115 the N/W 1110 transmits a control message containing information regarding the entire bandwidth according to frequency bands to the UE 1105 at a certain time point. Examples of the certain time point are when the N/W 1110 receives a transceiver report from the UE 1105, or when the N/W 1110 recognizes that a plurality of transceivers, whose supporting bandwidths differ from each other, support at least some frequency bands that are supported in a N/W that controls a cell where the UE 1105 is located.

An example of the information regarding the entire bandwidth by frequency bands is described with reference to Table 6.

TABLE 6

| Information | | |
|---|---|---|
| Element Name | Singular/Plural | Contents |
| > Frequency band | Plural | Contents exist by the number of |
| information | | frequency bands provided by |
| | | the system |
| >> Serial number of | Singular | Identifier for identifying |
| frequency band | | frequency bands |
| >> Bandwidth | Singular | Entire bandwidth of a |
| | | corresponding frequency band |

When the UE 1105 receives the information regarding the entire bandwidth by frequency bands, it pre-maps preferable transceivers to frequency bands correspondingly and respectively in step 1117.

The UE 1105 pre-maps a preferable transceiver with respect to the frequency band providing the widest bandwidth. The UE 1105 pre-maps a transceiver as a preferable transceiver with respect to a frequency band providing the widest bandwidth, where the transceiver is one of the transceivers that supports the frequency band and has the widest bandwidth. After that, the UE 1105 pre-maps a transceiver as a preferable transceiver with respect to a frequency band providing the next widest bandwidth, where the transceiver is one of the remaining transceivers that support the frequency band, was not pre-mapped as a preferable transceiver for other frequency bands, and has the widest bandwidth among the remaining transceivers. If all transceivers supporting corresponding frequency bands have already been pre-mapped as preferable transceivers for other frequency bands, the UE 1105 pre-maps the frequency band to one of the transceivers supporting the frequency band, where the pre-mapped transceiver has a bandwidth that is most similar to that of the frequency band. The UE 1105 repeats these processes until the transceivers are pre-mapped with respect to all frequency bands.

Next, the UE 1105 determines whether the currently used transceiver is a preferable transceiver with respect to the currently used frequency band. If the UE 1105 determines that the currently used transceiver is not a preferable transceiver, the UE autonomously switches from the currently used transceiver to a preferable transceiver in step 1120. More particularly, the UE switches transceivers without further instruction from the N/W.

After that, the N/W 1110 transmits a control message to the UE 1105 in order to command the UE 1105 to aggregate a particular carrier with respect to a particular frequency band in step 1125. The control message contains information regarding a frequency band of a carrier to be aggregated, information regarding the center frequency, bandwidth information, etc. In step 1130, the UE 1105 autonomously selects a proper transceiver and maps it to a carrier to be newly aggregated. More specifically, the UE 1105 determines whether a preferable transceiver, pre-mapped to a frequency band of a carrier to be newly aggregated, is already being used. If the UE 1105 determines that a preferable transceiver is already being used, it determines whether the preferable transceiver is being used at a frequency band similar to that of a carrier to be newly aggregated. If the UE 1105 determines that a preferable transceiver is not being used or is being used at a frequency band similar to that of a carrier to be newly aggregated, it maps the preferable transceiver to a carrier to be aggregated. If the UE 1105 determines that a preferable transceiver is already being used at a frequency band different from that of a carrier to be newly aggregated, it selects one of the other transceivers that supports the frequency and a bandwidth that is most similar to the frequency band of a carrier to be newly aggregated and then maps it to the carrier.

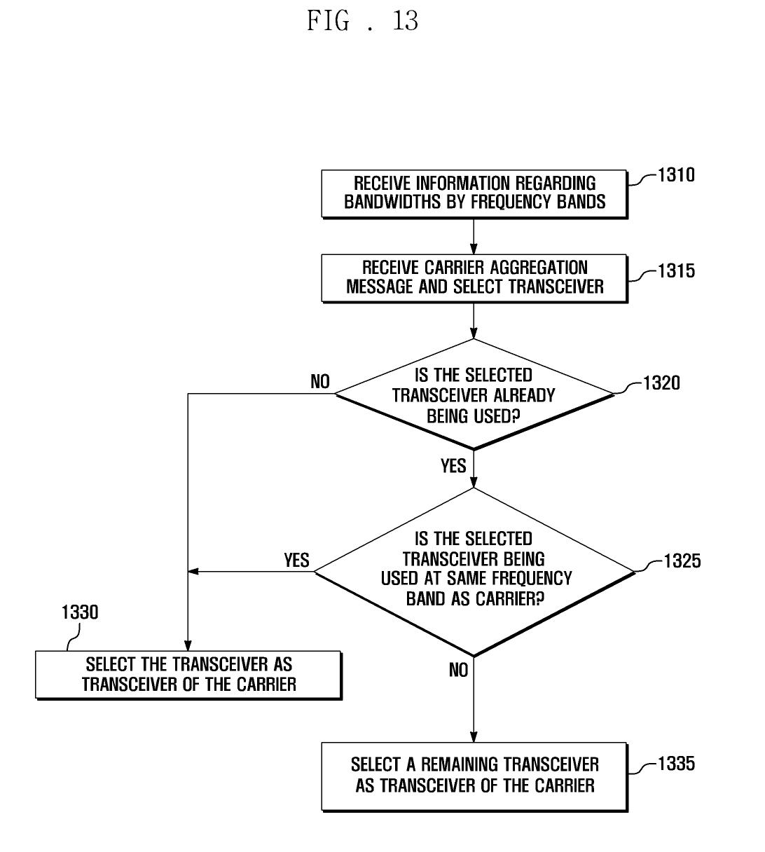

FIG. 12 is a flowchart describing operations of a UE according to an exemplary embodiment of the present invention.

The UE receives information regarding bandwidths according to frequency bands in step 1205. In an exemplary implementation, the information regarding bandwidths may be as illustrated in Table 6 as described above. The UE pre-maps between frequency bands and transceivers and determines the preferable transceivers according to frequency bands in step 1210. In an exemplary implementation, pre-mapping between the frequency bands and the transceivers may be performed as described above in step 1117 of FIG. 11.

When the UE receives a carrier aggregation message in step 1215, it determines whether a preferable transceiver is currently being used with respect to a frequency band of a carrier to be newly aggregated in step 1220. If the UE determines that a preferable transceiver is not currently being used at step 1220, it selects the preferable transceiver as a transceiver of the carrier in step 1230. On the contrary, if the UE determines that the UE is already using a preferable transceiver at step 1220, it determines whether the preferable transceiver is being used in a frequency band that is identical to that of the carrier to be newly aggregated in step 1225. If the UE determines that the preferable transceiver is being used in a frequency band that is identical to that of the carrier at step 1225, it proceeds with step 1230 where the preferable transceiver is selected as a transceiver of the carrier to be newly aggregated.

If the UE determines that the preferable transceiver is already being used in a frequency band that differs from that of the carrier to be newly aggregated at step 1225, it selects one of the transceivers as a transceiver of the carrier in step 1235. Here, the selected transceiver supports a frequency band of a carrier to be newly aggregated, is not the preferable transceiver, is not yet used, but supports a bandwidth most similar to that of the frequency band of the carrier that will be newly aggregated.

The exemplary embodiment illustrated in FIG. 12 may be modified in such a way that, instead of the process of pre-mapping between the frequency band and transceiver, the UE regards a transceiver, which provides a bandwidth most similar to the entire bandwidth of a frequency band of a carrier aggregation to be newly aggregated, as a preferable transceiver of the carrier and performs a corresponding operation each time the UE receives a carrier aggregation message. That is, the method of FIG. 12 may be performed in such a way as to decide a preferable transceiver each time that the UE receives a carrier aggregation message, and thus effectively omitting step 1210.

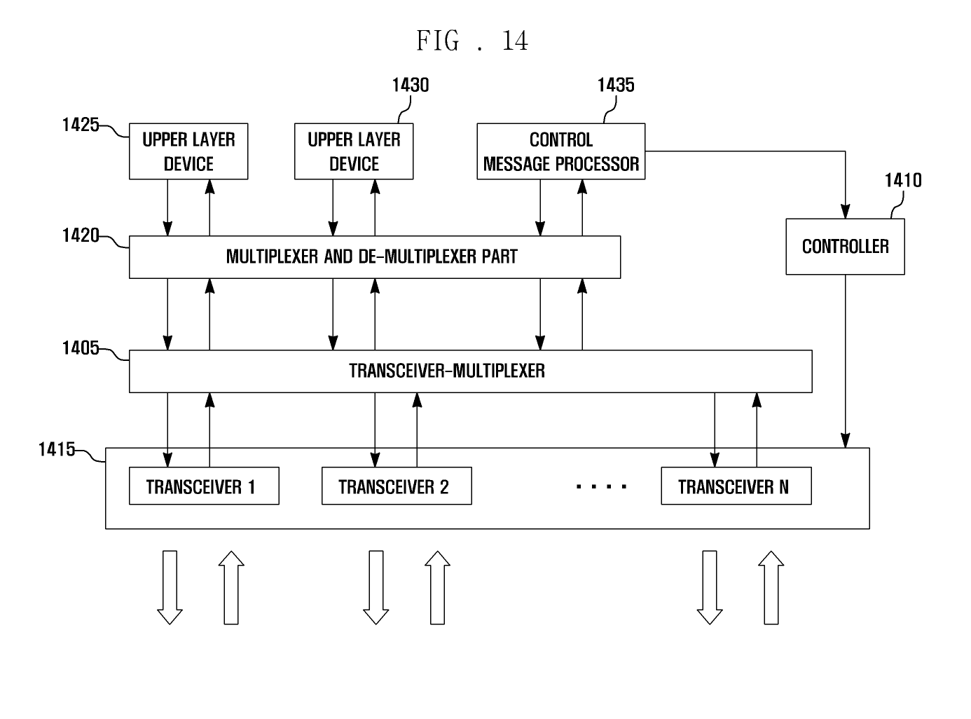

FIG. 13 is a flowchart describing operations of a UE according to an exemplary embodiment of the present invention.

Referring to FIG. 13, the UE receives information regarding bandwidths according to frequency bands in step 1310. In an exemplary implementation, the information regarding bandwidths may be as illustrated in Table 6 as described above. When the UE receives a carrier aggregation message in step 1315, it selects one of the transceivers that can support a frequency band of a carrier to be newly aggregated and a bandwidth most similar to the entire bandwidth of the frequency band, and determines whether the selected transceiver is already being used in step 1320.

If the UE determines that the selected transceiver is not being used at step 1320, it selects the transceiver as a transceiver of the carrier in step 1330. If the UE determines that the selected transceiver is already being used at step 1320, it determines whether the transceiver is being used in a frequency band that is the same as that of the carrier to be newly aggregated in step 1325. If the UE determines that the transceiver is being used in a frequency band that is the same as that of the carrier at step 1325, it proceeds to step 1330 where the transceiver is finally selected as a transceiver of the carrier. If the UE determines that the transceiver is already being used in a frequency band different from that of the carrier to be newly aggregated at step 1325, it selects one of the remaining transceivers as a transceiver of the carrier in step 1335. Here, the remaining transceivers refer to transceivers that do not include a transceiver that is already being used.

The above described exemplary embodiment may be modified in such a way as to select one of the remaining transceivers, which supports a frequency band of a carrier to be newly aggregated and a bandwidth closest to that of the frequency band. The remaining transceivers do not include a transceiver that is already being used.

FIG. 14 is a view illustrating a configuration of a UE according to an embodiment of the present invention.

Referring to FIG. 14, the UE includes a transceiver-multiplexer 1405, a transceiver part 1415, a controller 1410, a multiplexer and de-multiplexer part 1420, a control message processor 1435, and upper layer devices 1425 and 1430.

The transceiver part 1415 includes a plurality of transceivers (i.e., Transceiver 1, Transceiver 2, . . . Transceiver N) each of which receives forward data and control signals and transmits reverse data and control signals at a frequency band.

The transceiver-multiplexer 1405 receives signals from the plurality of transceivers and transfers them to the upper layers. Similarly, the transceiver-multiplexer 1405 receives signals from the upper layers and transfers them to the appropriate transceiver.

The controller 1410 turns on/off the transceivers according to the information from the control message processor 1435. That is, the controller 1410 may receive a command to turn on a particular transceiver from the control message processor 1435 and turns on the transceiver. The controller 1410 turns off a transceiver if all carriers mapped to the transceiver are released. If the control message processor 1435 commands the controller 1410 to aggregate a carrier at a particular bandwidth, the controller 1410 selects a transceiver to which the carrier is mapped.

The multiplexer and de-multiplexer part 1420 multiplexes data, generated in the upper layer devices 1425 and 1430 and the control message processor 1435 or de-multiplexes data received from a transceiver, and transfers them to the upper layer devices 1425 and 1430 and the control message processor 1435.

The control message processor 1435 processes a control message received from the network. In an exemplary embodiment, the control message processor 1435 transfers information regarding transceivers or information regarding the entire bandwidth by frequency bands, contained in the carrier aggregation message, to the controller 1410.

The upper layer devices 1425 and 1430 may be sorted according to types of services. The upper layer devices 1425 and 1430 process data generated through user services, such as File Transfer Protocol (FTP) or Voice over Internet Protocol (VoIP), for example, to transfer them to the multiplexer or process data transmitted from the de-multiplexer to transfer them to the service application of the upper layers.

As described above, a device and method for selecting a transceiver, according to exemplary embodiments of the present invention, can maximize the potential transmission rate of the UE that includes a plurality of transceivers.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for selecting, by a network entity, a transceiver of a mobile terminal including a plurality of transceivers, the method comprising:
receiving information about the plurality of transceivers;
receiving information about at least one transceiver being used; and
transmitting a transceiver switching message.

2. The method of claim 1, wherein the receiving of information about the plurality of transceivers comprises receiving at least one of a transceiver identifier, a list of frequencies supported by a transceiver, and a maximum bandwidth of a transceiver.

3. The method of claim 1, wherein the receiving of information about the at least one transceiver being used comprises receiving at least one of a transceiver identifier, and a frequency identifier.

4. The method of claim 1, further comprising:
respectively mapping a plurality of supportable frequency bands to the plurality of transceivers; and
determining a preferable transceiver associated with each supportable frequency band.

5. The method of claim 4, wherein the transmitting of the transceiver switching message comprises transmitting at least one of a transceiver identifier of the preferable transceiver associated with a frequency band, and a frequency identifier of the preferable transceiver associated with the frequency band.

6. The method of claim 1, further comprising transmitting a carrier aggregation message.

7. The method of claim 6, wherein the transmitting of the carrier aggregation message comprises transmitting at least one of a frequency band, center frequency information, and bandwidth information of one or more carriers to be aggregated.

8. The method of claim 6, further comprising:
determining a preferable transceiver for a carrier to be aggregated;
determining if the preferable transceiver is being used;
if the preferable transceiver is not being used, selecting the preferable transceiver as the transceiver for the one or more carriers to be aggregated; and
if the preferable transceiver is being used, determining if the preferable transceiver is being used at a frequency of the one or more carriers to be aggregated.

9. The method of claim 8, further comprising, if the preferable transceiver is being used at a frequency of the one or more carriers to be aggregated, selecting the preferable transceiver as the transceiver for the one or more carriers to be aggregated, and, if the preferable transceiver is not being used at a frequency of the one or more carriers to be aggregated, selecting another transceiver for the one or more carriers to be aggregated.

10. A method for determining, by a mobile terminal including a plurality of transceivers, a transceiver for use by the mobile terminal, the method comprising:
transmitting information about the plurality of transceivers;
transmitting information about at least one transceiver being used; and
receiving a transceiver switching message.

11. The method of claim 10, wherein the transmitting of information about the plurality of transceivers comprises transmitting at least one of a transceiver identifier, a list of frequencies supported by a transceiver, and a maximum bandwidth of a transceiver.

12. The method of claim 10, wherein the transmitting of information about the at least one transceiver being used comprises transmitting at least one of a transceiver identifier, and a frequency identifier.

13. The method of claim 12, wherein the transmitting of information about the at least one transceiver being used is performed when at least one of the mobile terminal transitions from an idle state to a connected state and the mobile terminal performs a handover from a heterogeneous network.

14. The method of claim 10, wherein the receiving of the transceiver switching message comprises receiving at least one of a transceiver identifier, and a frequency identifier.

15. The method of claim 14, further comprising:
switching from a transceiver being used to a transceiver associated with the at least one of the transceiver identifier and the frequency identifier; and
transmitting a switching acknowledgement message.

16. The method of claim 10, further comprising receiving a transceiver enquiry message before the transmitting of information about the transceivers.

17. The method of claim 10, further comprising receiving a carrier aggregation message.

18. A method for determining, by a mobile terminal including a plurality of transceivers, a transceiver for use by the mobile terminal, the method comprising:
receiving spectrum information including bandwidth by frequency information;
respectively mapping preferable transceivers to frequency bands included in the spectrum information; and
switching from a first transceiver to a second transceiver based on the received spectrum information.

19. The method of claim 18, wherein the switching from the first transceiver to the second transceiver comprises determining if the first transceiver is the preferable transceiver for the frequency band being used.

20. The method of claim 18, wherein the respectively mapping of the preferable transceivers to frequency bands comprises:
determining a frequency band, from the spectrum information, that provides the widest bandwidth; and
determining a transceiver, from the plurality of transceivers, that supports the determined frequency band and that has the widest bandwidth.

21. The method of claim 18, further comprising:
receiving a carrier aggregation message;
selecting a preferred transceiver corresponding to a frequency of one or more carriers to be aggregated; and
mapping the selected transceiver to the one or more carriers to be aggregated.
